(19) United States
(12) Patent Application Publication
(10) Pub. No.: US 2002/0144941 A1
(43) Pub. Date: Oct. 10, 2002

(54) Photooxidation water treatment device

(76) Inventor: Yushi Kawaji, Sakai-shi (JP)

Correspondence Address: James V. Costigan, Esq., HEDMAN & COSTIGAN, P.C., Suite 2003, 1185 Avenue of the Americas, New York, NY, 10036-2646, US

(21) Appl. No.: 10/047,703

(22) Filed: Jan. 15, 2002

(30) Foreign Application Priority Data
Jan. 29, 2001 (JP) 2001-019927

(51) Int. Cl. C02F 1/50

(52) U.S. Cl. 210/192; 422/186.07; 250/435; 210/437

(57) ABSTRACT

A photooxidation water treatment device includes a reaction chamber having an inlet for water to be treated in one end portion thereof and an outlet for treated water in the other end portion thereof, ozone supplying means for supplying ozone to the water to be treated, and ultraviolet ray irradiation means disposed in the reaction chamber for irradiating ultraviolet ray to the water to be treated and the ozone supplied to the water to be treated. The water to be treated supplied with the ozone flows through the reaction chamber from the inlet to the outlet along the ultraviolet ray irradiation means. The inlet which is provided in the lower portion of the reaction chamber is arranged horizontally obliquely with respect to a line normal to the circumference of the reaction chamber so as to cause a spiral flow of water to be treated.

### BACKGROUND OF THE INVENTION

This invention relates to a water treatment device decomposing contaminants in water to be treated by utilizing the photooxidation reaction and, more particularly, to a water treatment device of this type suitable for decomposing contaminants in raw water such as river water, underground water, industrial water, waste water and water in swimming pools.

An example of a prior art deodorizing equipment which constitutes the background of the present invention is disclosed in the specification of Japanese Utility Model Reg. No. 3065849. The deodorizing equipment disclosed in this specification comprises a scrubber to which cleaning water for cleaning gas by absorbing and removing odor in the gas is supplied in circulation and a photooxidation treatment means which is connected to the scrubber and decomposes contaminants contained in the cleaning water. This photooxidation treatment means comprises oxidizing agent supplying means for supplying an oxidizing agent to the cleaning water which is supplied to the scrubber in circulation, ozone supplying means for supplying ozone to the cleaning water and ultraviolet ray irradiation means for irradiating ultraviolet ray to the cleaning water, oxidizing agent and ozone.

In this deodorizing equipment, gas is cleaned by the cleaning water in the scrubber and odor in the gas is absorbed and removed by the cleaning water. Further, in this deodorizing equipment, contaminants in the cleaning water which is supplied to the scrubber in circulation is decomposed by supplying the oxidizing agent and ozone to the cleaning water by the oxidizing supplying means and the ozone supplying means and irradiating ultraviolet ray to the cleaning water, oxidizing agent and ozone by the ultraviolet irradiation means.

Contaminants in the cleaning water for the scrubber can be decomposed by the prior art equipment. It is, however, desired to decompose contaminants which are contained in a higher concentration in raw water such as river water, underground water, industrial water, waste water and water in swimming pools efficiently.

It is, therefore, an object of the present invention to provide a photooxidation water treatment device which is capable of decomposing contaminants which are contained in a high concentration in such raw water efficiently.

### SUMMARY OF THE INVENTION

For achieving the object of the invention, there is provided a photooxidation water treatment device comprising a reaction chamber having an inlet for water to be treated in one end portion thereof and an outlet for treated water in the other end portion thereof, ozone supplying means for supplying ozone to the water to be treated, and ultraviolet ray irradiation means disposed in the reaction chamber for irradiating ultraviolet ray to the water to be treated and the ozone supplied to the water to be treated, said water to be treated supplied with the ozone flowing through the reaction chamber from the inlet to the outlet along the ultraviolet ray irradiation means.

According to the invention, by irradiating ultraviolet ray to the water to be treated and the ozone, the contaminants in the water to be treated are decomposed.

In one aspect of the invention, the device further comprises oxidizing agent supplying means for supplying an oxidizing agent to the water to be treated.

Presence of the oxidizing agent accelerates decomposition of the contaminants

In an important aspect of the invention, the device further comprises spiral flow creation means for causing the water to be treated to flow spirally along the ultraviolet ray irradiation means.

According to this aspect of the invention, the water to be treated, ozone and oxidizing agent flow spirally along the ultraviolet ray irradiation means and, therefore, the water to be treated, ozone and oxidizing agent are caused to keep in contact with the ultraviolet ray for a longer time and hence take a longer reaction time than in a case where they do not flow spirally but flow straight ahead with the result that contaminants in the water to be treated can be decomposed more efficiently.

In another aspect of the invention, said reaction chamber is a vertically erected column and said spiral flow creation means is the inlet of the water to be treated which is provided in the lower portion of the reaction chamber and arranged horizontally obliquely with respect to a line normal to the circumference of the reaction chamber.

In another aspect of the invention, said spiral flow creating means further comprises an upper inlet provided between the inlet and the outlet, an upper outlet provided between the inlet and the upper inlet, a pipe line connecting the upper outlet with the upper inlet, and a pump provided in the pipe line for supplying the water to be treated from the upper outlet to the upper inlet.

The circulation path formed by the upper outlet, the pump and the upper inlet enhances the spiral flow of the water to be treated and thereby enhances decomposition of the contaminants.

In another aspect of the invention, said ozone supplying means comprises air supplying means for supplying air to a region in the vicinity of the ultraviolet ray irradiation means to enable the ozone to be produced by irradiation of the ultraviolet ray from the ultraviolet ray irradiation means to the air.

Since the ozone is produced by irradiation of ultraviolet ray to the air, no other sources of ozone is required and reduction of cost thereby is achieved.

In another aspect of the invention, said ozone supplying means further comprises a pipe line connecting the region in the vicinity of the ultraviolet ray irradiation means with the upper inlet and an ejector provided in the pipe line connecting the region with the upper inlet.

Since the ejector is used for ejecting the ozone to the upper inlet, the ozone can be introduced into the reaction chamber in very fine ozone foams and distributed uniformly in the water to be treated and this enhances decomposition of the contaminants.

In one aspect of the invention, the device further comprises a radical reaction chamber connected to the reaction chamber for decomposing residual contaminants in the treated water from the reaction chamber with the aid of radicals contained in the treated water

According to this aspect of the invention, the residual contaminants in the treated water which come out of the outlet of the reaction chamber are decomposed by radicals which are contained in the treated water and, therefore, the contaminants in the raw water are decomposed almost completely.

In an embodiment of the radical reaction chamber, the radical reaction chamber contains adsorbent which adsorbs the residual contaminants for decomposition with the radicals contained in the treated water.

These and other objects and features of the invention will become more apparent from the description made below with reference to the accompanying drawings.

### BRIEF DESCRIPTION OF THE DRAWINGS FIG. 1 is a perspective view of an embodiment of the photooxidation water treatment device made according to the invention;

FIG. 2 is a schematic vertical sectional view of a reaction chamber of the photooxidation water treatment device shown in FIG. 1; and

FIG. 3 is a cross-sectional view of the reaction chamber.

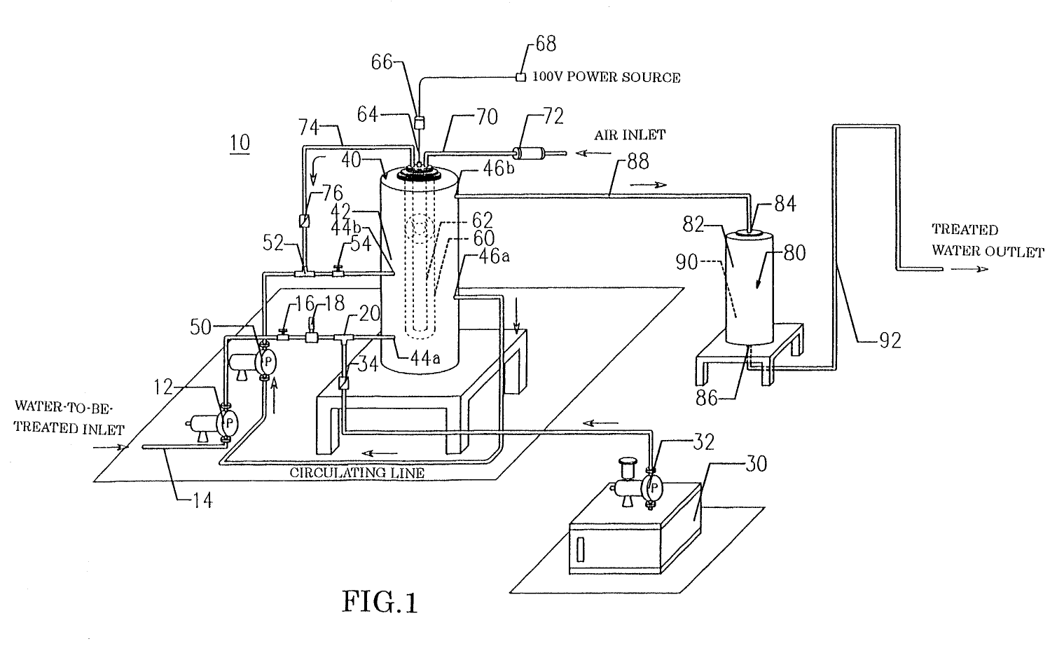

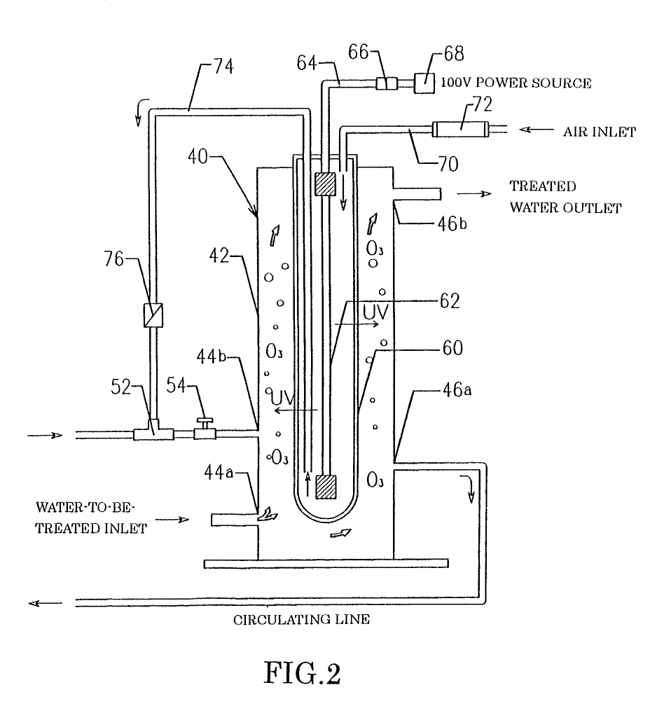

### Description of the Preferred Embodiments

Referring to the drawings, a photooxidation water treatment device 10 includes a pump 12 for water to be treated. The pump 12 sucks in and sends out water to be treated such as water to be used for various purposes and also waste water. To the inlet of the pump 12 is connected one end of a water supply pipe 14. The other end of the water supply pipe 14 is submerged in water contained in a reservoir (not shown). The outlet of the pump 12 is connected to one end of a T pipe 20 through a valve 16 and a flow meter 18. The outlet of the pump 12, the valve 15, the flow meter 18 and the T pipe 20 are connected by means of proper pipes. Likewise, component parts to be described below are connected by means of proper pipes.

To a middle portion of the T pipe 20 is connected an oxidizing agent tank 30 which constitutes the oxidizing agent supplying means via a supply pump 32 and a check valve 34. More specifically, the oxidizing agent tank 30 is connected to the inlet of the supply pump 32 and the outlet of the supply pump 32 is connected to the middle portion of the T pipe 20 via the check valve 34. The oxidizing agent tank 30 stores an oxidizing agent such as sodium hypochlorite. As the oxidizing agent, agents other than sodium hypochlorite including, e.g., ozone, hydrogen peroxide, chlorine and potassium permanganate may also be used. The other end of the T pipe 20 is connected to an ultraviolet ray-ozone reaction chamber 40. The reaction chamber 40 comprises a container 42 in the form, e.g., of a hollow column. The container 42 is formed in its lower portion with a first inlet 44a. The T pipe 20 is connected to the first inlet 44a of the container 42 of the reaction chamber 40.

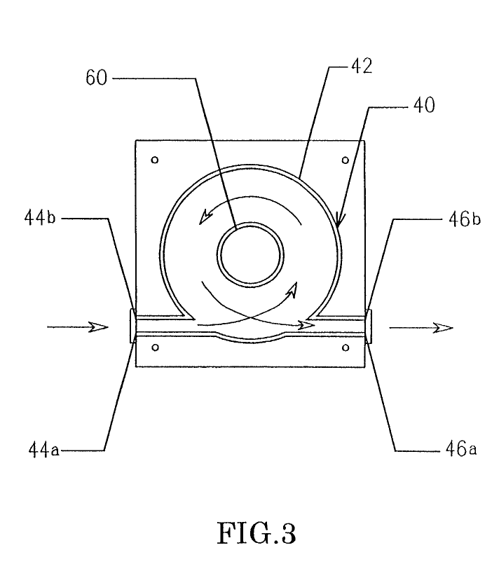

The container 42 of the reaction chamber 40 is formed also with a second inlet 44b, a first outlet 46a and a second outlet 46a. The second inlet 44b is formed at a location which is about one third of the height of the container 42 from the lower end of the container 42 and above the first inlet 44a. The first outlet 46a is formed at a location which is in the middle of the first inlet 44a and the second inlet 44b and on substantially the opposite side of the first inlet 44a and the second inlet 44b. The second outlet 46a is formed at a location which is in the upper portion of the container 42 and above the first outlet 46a. As shown in FIG. 3, the first inlet 44a, second inlet 44b, first outlet 46a and second outlet 46a are arranged horizontally obliquely with respect to a line normal to the circumference of the container 42 so that water to be treated will flow spirally from the first inlet 44a and the second inlet 44b to the first outlet 46a and the second outlet 46a about a protection tube 60 to be described later and flow counterclockwise as viewed from above about the protection tube 60.

The first outlet 46a is connected to the inlet of a circulating pump 50. The outlet of the circulating pump 50 is connected to one end of an ejector 52. The other end of the ejector 52 is connected to the second inlet 44b via a valve 54. When water to be treated is suppled to one end of the ejector 52, the ejector 52 delivers out the water to be treated from the other end thereof and, simultaneously, produces sucking force in the middle portion thereof. In other words, the ejector 52 produces sucking force in the middle portion thereof by utilizing pressure difference which is generated when water to be treated passes from one end to the other end of the ejector 52. In the central portion of the container 42 is coaxially provided a portion of a protection tube 60 excepting the upper end portion thereof. The protection tube 60 is shaped in the form a hollow column having a smaller diameter than the container 42, is made, for example, of quartz glass and is suspended vertically in the container 42. Inside of the protection tube 60 is coaxially provided a mercury lamp 62 of a straight shape which constitutes the ultraviolet ray irradiation means. The mercury lamp 62 irradiates ultraviolet ray of specific wavelengths and is connected to a power source 68 via a cable 64 and a connector 66.

To the upper end portion of the protection tube 60 is connected a filter 72 via a pipe 70 which constitutes the air supplying means To the protection tube 60 is also connected one end of another pipe 74. This pipe 74 is provided in such a manner that its one end is disposed in the lower portion of the inside space of the protection tube 60. The other end of the pipe 74 is connected to the middle portion of the ejector 52 via a check valve 76.

The second outlet 46a is connected to a radical reaction chamber 80 which comprises a container 82 which is in the form, e.g., of a hollow column. The container 82 is formed in its upper end portion with an inlet 84 and in its lower end portion an outlet 86. The second outlet 46a of the ultraviolet ray-ozone reaction chamber 40 is connected to the inlet 84 of the radical reaction chamber 80 via a pipe 88. This pipe 88 should be made as short as possible for transmitting treated water and radicals efficiently from the ultraviolet ray-ozone reaction chamber 40 to the radical reaction chamber 80. The container 82 contains adsorbent 90 such as activated carbon for adsorbing residual contaminant. To the outlet 86 of the container 82 is connected to one end of a drain pipe 92.

In this photooxidation water treatment device 10, water to be treated is supplied from the water supply pipe 14 to the container 42 of the ultraviolet ray-ozone reaction chamber 40 via the pump 12, valve 16, flow meter 18, T pipe 20 and the first inlet 44a.

In this device 10, the oxidizing agent stored in the oxidizing agent tank 30 is supplied to the water to be treated in the container 42 via the supply pump 32, check valve 34, T pipe 20 and first inlet 44a.

In this device 10, air is supplied, by the sucking force produced by the ejector 52, to the inside of the protection tube 60 via the filter 72 and the pipe 70. By irradiating ultraviolet ray to the air in the protection tube 60 with the mercury lamp 62, ozone is generated. The ozone is supplied to the water to be treated in the container 42 via the pipe 74, check valve 76, ejector 52, valve 54 and second inlet 44b.

In this device 10, ultraviolet ray is irradiated by the mercury lamp 62 to the water to be treated, oxidizing agent and ozone in the container 42 and contaminants in the water to be treated are thereby decomposed. In this case, by the synergistic effect produced by supply of the oxidizing agent, supply of ozone and irradiation of ultraviolet ray, the reaction energy of the oxidizing agent for decomposing contaminants in the water, the reaction energy of ozone for decomposing the contaminants in the water and the optical energy of ultraviolet ray for decomposing the contaminants in the water are multiplied about ten times to about ten thousand times. More specifically, since ultraviolet ray has such a high optical energy that it not only decomposes the contaminants directly but also generates various types of radicals by decomposing water molecules of the water to be treated and the oxidizing agent. These radicals have a high oxidation-reduction potential. Hydroxy radicals which are generated by decomposing of the oxidizing agent and water by irradiation of ultraviolet ray have a high oxidation-reduction potential which is second to fluorine and work very efficiently for decomposing the contaminants. These radicals can also be generated from the oxidizing agent only but, under irradiation of ultraviolet ray, the reaction speed is accelerated in comparison with the case of using the oxidizing agent only. In case of ozone, the reaction speed is accelerated by about ten times to about ten thousand times owing to the synergistic effect. Accordingly, in this device 10, the contaminants in the water to be treated can be decomposed efficiently.

Particularly in this device 10, the water to be treated, oxidizing agent, ozone and radicals flow spirally about the protection tube 60 in counterclockwise direction in the container 42 from the first inlet 44a and the second inlet 44b to the first outlet 46a and the second outlet 46a and, therefore, the water to be treated, ozone and oxidizing agent are caused to keep in contact with the ultraviolet ray for a longer time and hence take a longer reaction time than in a case where they do not flow spirally whereby the efficiency for decomposing the contaminants in the water to be treated is greatly improved. Moreover, since the water to be treated, oxidizing agent, ozone and radicals circulate from the first outlet 46a to the container 42 via the circulating pump 50 and the second inlet 44b, the spiral flow in the container 42 is significantly enhanced.

In the device 10, since air and ozone are supplied by the circulating pump 50 and the ejector 52, provision of outside air compressor and pump for supplying air and ozone is unnecessary.

In the device 10, the treated water containing radicals is transmitted from the ultraviolet ray-ozone reaction chamber 40 to the radical reaction chamber 80 through the pipe 88. In the radical reaction chamber 80, residual contaminants in the treated water are adsorbed once to the adsorbent 90 contained in the container 82 and decomposed with the radicals while they are adsorbed to the adsorbent. As a result, the contaminants in the treated water are decomposed almost completely and the treated water which is substantially free of the contaminants is drained from the outlet 92. Since the adsorbent 90 in the container 82 adsorbs the contaminants only temporarily until they are decomposed with the radicals, the adsorbent 90 can enjoy a longer life than in a case where an adsorbent adsorbs contaminants permanently.

### EXAMPLE

### Example No. 1

Experiments have been made to treat sewage water from a purification tank type flush toilet to remove contaminants by the above described photooxidation water treatment device 10 (device No. 2) and a device which is of the same construction as the device 10 excepting that the circulation route of the water to be treated from first outlet 46a, circulating pump 50, ejector 52, valve 54 and second inlet 44b has been omitted and that air including ozone is introduced into the container 42 in the lower portion of the container 42 (device No. 1).

Results of measurement of pH, BOD, COD and T-N of the treated water after the treatment in the devices No. 1 and No. 2 are shown in the following Table 1.

TABLE 1

| | | After treatment | After treatment |
|---|---|---|---|
| | Before treatment | by Device No. 1 | by Device No. 2 |
| pH | 6.8 | 6.9 | 7.2 |
| BOD | 4.5 | 1 | less than 1 |
| COD | 12 | 4.5 | 2.5 |
| T-N | 49 | 19.61 | 9.5 |

From the results shown in Table 1, it will be understood that pH, BOD, COD and T-N in the waste water are significantly improved by the devices No. 1 and No. 2 and also that the device No. 2 which includes the circulation route of the water to be treated has decomposed the contaminants more efficiently than the device No. 1 which does not include such circulation route.

### Example No. 2

Experiments have been made to treat drainage from a wood chip race course to remove contaminants contained in the drainage by the above described devices No. 1 and No. 2

Results of measurement of pH, BOD, COD and T-N of the treated water after the treatment in the devices No. 1 and No. 2 are shown in the following Table 2.

TABLE 2

| | | After treatment | After treatment |
|---|---|---|---|
| | Before treatment | by Device No. 1 | by Device No. 2 |
| pH | 6.4 | 6.7 | 6.8 |
| BOD | 160 | 12.0 | 5.0 |
| COD | 57 | 14.0 | 8.0 |
| T-N | 6.5 | 1.8 | 1 |

From the results shown in Table 2, it will be understood that pH, BOD, COD and T-N in the waste water are significantly improved by the devices No. 1 and No. 2 and also that the device No. 2 has decomposed the contaminants more efficiently than the device No. 1.

The ultraviolet ray-ozone reaction chamber 40 used in the device 10 has been described for illustrative purpose only and other types of ultraviolet ray-ozone reaction chamber may be used. For example, in the above described reaction chamber 40, the water to be treated flows spirally in counterclockwise direction as viewed from above but the water to be treated may flow spirally in clockwise direction.

The shape of the ultraviolet ray-ozone reaction chamber 40 is not limited to a cylindrical shape described above but it may be other shape such as a hollow square pillar, an oval column or a sphere.

The locations of the first outlet 46a and ther second inlet 44b may be changed depending upon factors such as nature and quality of water to be treated.

As the oxidizing agent supplying means, the ozone supplying means, the ultraviolet ray irradiation means and the radical reaction chamber, other structures than has been described above may be used.

For example, the mercury lamp protection tube and the mercury lamp may be provided in plural sets in the reaction chamber to increase the efficiency of the photooxidation reaction.

The shape of the mercury lamp is not limited to the straight one described above but mercury lamps of other shapes such as a U-shaped one, a spiral one and a parallel type one may be used.

The radical reaction chamber is not limited to the one of the above described embodiment but various other structures may be employed so long as they can retain contaminants in the radical reaction chamber for a sufficient time for decomposing them with radicals contained in the treated water flowing through the radical reaction chamber. Filter materials such as filter cloth may be served as suitable materials for retaining contaminants in the radical reaction chamber.

According to the invention, a photooxidation water treatment device capable of efficiently decomposing contaminants in water to be treated can be provided. Contaminants which can be decomposed by the device of the invention include dioxin, organic solvents, organic oxides, pesticides and other organic materials and the device is effective for reducing BOD and COD, for killing bacteria and algae, and for decolorization and deodorizing.

The device is applicable to, e.g., removing contaminants from underground water, maintenance of a closed water area such as a pond of a garden and a swimming pool, and recycling or purification of waste water and rain water etc.

What is claimed is:

1. A photooxidation water treatment device comprising:
a reaction chamber having an inlet for water to be treated in one end portion thereof and an outlet for treated water in the other end portion thereof;
ozone supplying means for supplying ozone to the water to be treated; and
ultraviolet ray irradiation means disposed in the reaction chamber for irradiating ultraviolet ray to the water to be treated and the ozone supplied to the water to be treated;
said water to be treated supplied with the ozone flowing through the reaction chamber from the inlet to the outlet along the ultraviolet ray irradiation means.

2. A photooxidation water treatment device as defined in claim 1 further comprising oxidizing agent supplying means for supplying an oxidizing agent to the water to be treated.

3. A photooxidation water treatment device as defined in claim 1 further comprising spiral flow creation means for causing the water to be treated to flow spirally along the ultraviolet ray irradiation means.

4. A photooxidation water treatment device as defined in claim 3 wherein said reaction chamber is a vertically erected column and said spiral flow creation means is the inlet of the water to be treated which is provided in the lower portion of the reaction chamber and arranged horizontally obliquely with respect to a line normal to the circumference of the reaction chamber.

5. A photooxidation water treatment device as defined in claim 4 wherein said spiral flow creating means further comprises an upper inlet provided between the inlet and the outlet, an upper outlet provided between the inlet and the upper inlet, a pipe line connecting the upper outlet with the upper inlet, and a pump provided in the pipe line for supplying the water to be treated from the upper outlet to the upper inlet.

6. A photooxidation water treatment device as defined in claim 1 wherein said ozone supplying means comprises air supplying means for supplying air to a region in the vicinity of the ultraviolet ray irradiation means to enable the ozone to be produced by irradiation of the ultraviolet ray from the ultraviolet ray irradiation means to the air.

7. A photooxidation water treatment device as defined in claim 5 wherein said ozone supplying means comprises air supplying means for supplying air to a region in the vicinity of the ultraviolet ray irradiation means to enable the ozone to be produced by irradiation of the ultraviolet ray from the ultraviolet ray irradiation means to the air.

8. A photooxidation water treatment device as defined in claim 7 wherein said ozone supplying means further comprises a pipe line connecting the region in the vicinity of the ultraviolet ray irradiation means with the upper inlet and an ejector provided in the pipe line connecting the region with the upper inlet.

9. A photooxidation water treatment device as defined in claim 1 further comprising a radical reaction chamber connected to the reaction chamber for decomposing residual contaminants in the treated water from the reaction chamber with the aid of radicals contained in the treated water.

10. A photooxidation water treatment device as defined in claim 9 wherein said radical reaction chamber contains adsorbent which adsorbs the residual contaminants for decomposition with the radicals contained in the treated water.
